(19) United States
(12) Patent Application Publication
(10) Pub. No.: US 2006/0108275 A1
(43) Pub. Date: May 25, 2006

(54) Membrane filtration assemblies for sand filter retrofit

(76) Inventor: Pierre Lucien Cote, Dundas (CA)

Correspondence Address: BERESKIN AND PARR, 40 KING STREET WEST, BOX 401, TORONTO, ON, M5H 3Y2, CA

(21) Appl. No.: 11/268,622

(22) Filed: Nov. 8, 2005

Related U.S. Application Data
(60) Provisional application No. 60/625,565, filed on Nov. 8, 2004.

(51) Int. Cl. B01D 63/00

(52) U.S. Cl. 210/321.6; 210/436; 210/293; 210/321.72; 210/321.69

(57) ABSTRACT

This document describes a kit to integrate an immersed membrane into existing sand filters while minimizing changes to the existing plant. The kit is installed in-situ, optionally from all-plastic components that can be transported by a man, without the use of machinery. Permeate and air headers are built in-situ at the bottom of the sand filter tank. Modules are installed and removed from the top without having to disassemble any piping. Air (from degassing or after a membrane integrity test) is removed via the bottom through a fine tube inserted into the header. Modules can be installed without removing existing backwash channels. The retrofitted plant can be used with the existing feed inlet and filtrate outlets. The membrane modules produce a similar filtration rate to the existing sand filter to reduce the extent of any changes required to the remainder of the plant.

This is an application claiming the benefit under 35 USC 119(e) of U.S. application Ser. No. 60/625,565 filed Nov. 8, 2004. Application Ser. No. 60/625,565 is incorporated herein, in its entirety, by this reference to it.

### FIELD OF THE INVENTION

This invention relates to membrane filtration modules and membrane filtration processes.

### BACKGROUND OF THE INVENTION

Conventional and high rate, or rapid, sand filters are commonly used, for example, in municipal water supply plants. Sand filters may have reasonable filtration rates but provide only moderate quality filtration. Sand filters do not, for example, remove most bacteria or viruses. Accordingly, chemical disinfection, for example by chlorination, is required. Further, since sand filters are poor at removing small colloids, pretreatment is often required, for example, by flocculation or coagulation. For these and other reasons, many newly constructed municipal water supplies use membrane filters. Membrane filters remove a significant portion of the bacteria and solids and small colloids. While pretreatment may still be required, for example to reduce colour, the intensity of pretreatment is reduced. Further, while some chlorination of membrane permeate may be required to prevent growth of organisms in the distribution system, heavy chlorination for primary disinfection is not required. Since chlorine, and other treatment chemicals, may be both expensive and raise health concerns, reducing the use of treatment chemicals, and a higher quality product overall, often justify the use of membranes in new plants. However, there remains a large number of existing sand filtration plants which would be prohibitively expensive to decommission, dismantle and replace with membrane filtration plants

### SUMMARY OF THE INVENTION

It is an object of the present invention to improve on, or at least provide a useful alternative to, the prior art. It is another object of the invention to provide a membrane filtration apparatus or process. It is another object of the present invention to provide a membrane filtration system, or a method of converting a sand filter into a membrane filtration system. It is another object of the invention to provide a kit of items to integrate an immersed membrane into an existing sand filter.

The following summary is intended to introduce the reader to the invention but not to define it. The invention may reside in a combination or sub-combination of one or more apparatus elements or process steps described in this or other parts of this documents, for example the claims.

This document describes a kit to integrate an immersed membrane into existing sand filters while minimizing changes to the existing plant. The kit is installed in-situ, optionally from all-plastic components that can be transported by a man, without the use of machinery. Permeate and air headers are built in-situ at the bottom of the sand filter tank. Modules are installed and removed from the top without having to disassemble any piping. Air (from degassing or after a membrane integrity test) is removed via the bottom through a fine tube inserted into the header. Modules can be installed without removing existing backwash channels. The retrofitted plant can be used with the existing feed inlet and filtrate outlets. The membrane modules produce a similar filtration rate to the existing sand filter to reduce the extent of any changes required to the remainder of the plant.

### BRIEF DESCRIPTION OF THE DRAWINGS

Embodiments of the invention will next be described with reference to the following figures.

FIG. 1 is an isometric view of a module pedestal for a horizontal fiber module.

FIG. 2 is an isometric view of a module pedestal for a vertical fiber module.

FIG. 3a is a plan view of a filtration tank partially covered with module pedestals.

FIG. 3b is an elevation section of a filtration tank with modules of vertical hollow fibers.

FIG. 4 is an elevational section view of a module of horizontal hollow fibers on the pedestal of FIG. 1.

FIG. 5 is an elevational section view of a module of vertical hollow fibers on the pedestal of FIG. 2.

FIG. 6 is a schematic representation of part of an air extraction system.

### DETAILED DESCRIPTION OF THE EMBODIMENTS

Referring to the figures, the bottom 8 of a filtration tank 10, formerly used as a sand filter, is prepared to install an immersed membrane retrofit kit by removing the existing underdrain system and pouring a leveled layer of concrete into which tracks (not shown) are optionally inserted to secure the module pedestals 12.

The following description is generally based on ZeeWeed-1000 like modules but can also be realized with a different module. Such modules are described in U.S. Patent No. 6,325,928 issued Dec. 4, 2001, which is incorporated herein by this reference to it. Another specific example is given for a module of vertical hollow fibers having an air passage through its lower header.

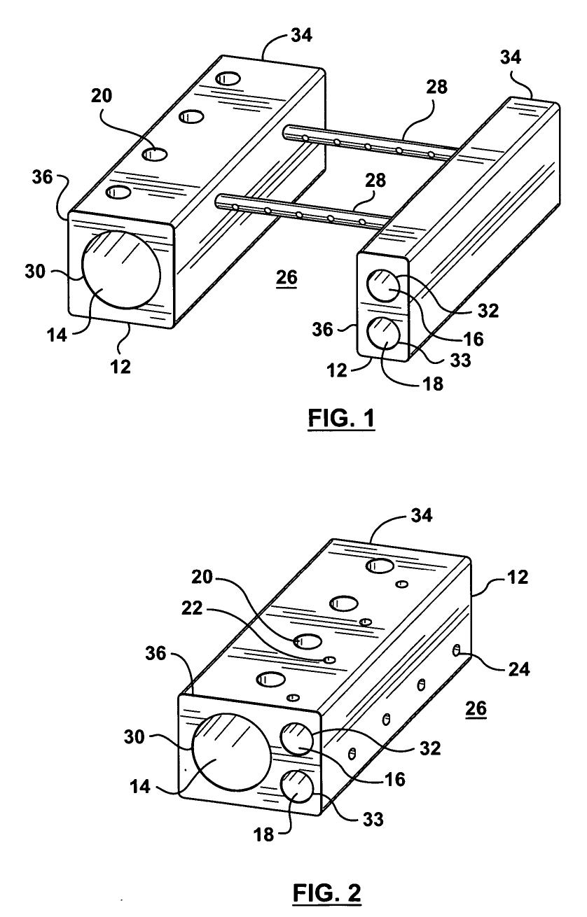

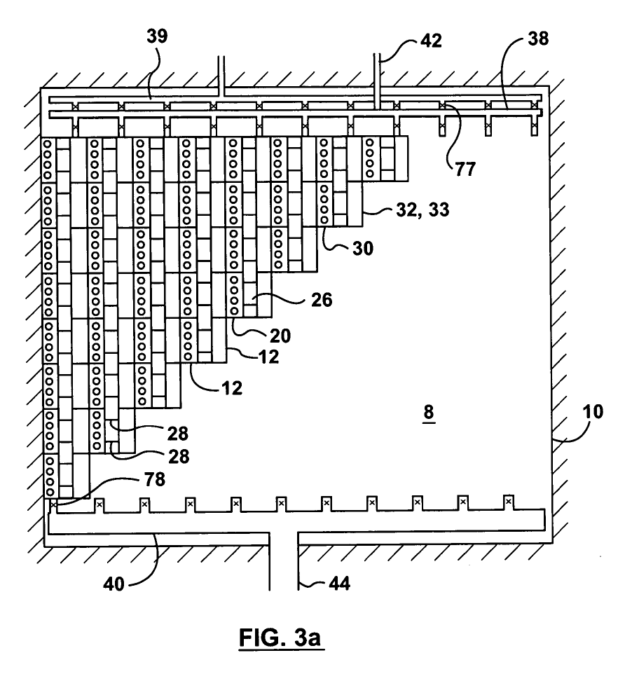

The retrofit building block is a module pedestal 12 as shown in FIGS. 1 or 2 for horizontal and vertical fibres, respectively. Each pedestal 12 is a plastic block that can be fixed at the bottom of the tank and may contain or form, alone or in combination with other pedestals 12: a section of permeate conduit 14; a section of aeration conduit 16; a section of air removal conduit 18; connectors for permeate 20, scouring air 22 and permeate air removal 24; and, a feed-and-drain channel 26 and aeration pipes 28 (horizontal fibres).

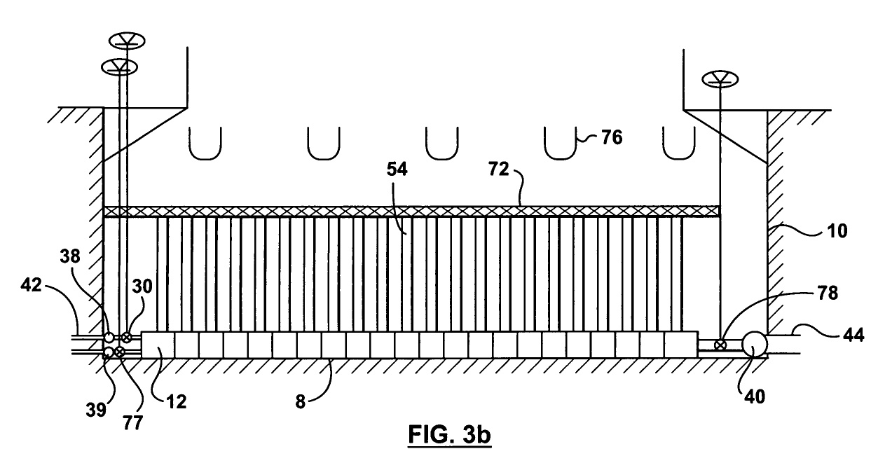

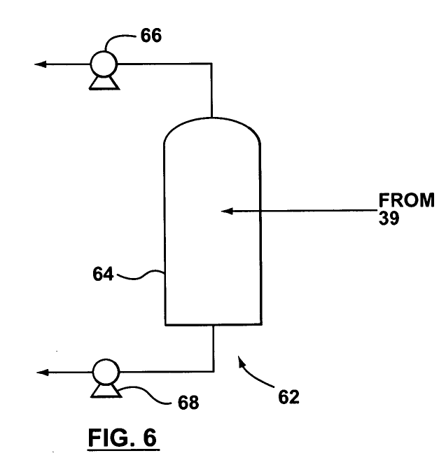

Pedestals 12 are laid at the bottom 28 of the tank 10 and connected longitudinally to form permeate 30 and aeration headers 32 and air removal headers 33 (FIG. 3); each pedestal 12 has a male 34 and female end 36. The bottom 8 of the tank 10 is completely covered by module pedestals 12 except for the end(s) where room is left for connecting permeate 30 and air 32 headers into manifolds 38, 40 that tie to the existing sand filter piping network 42, 44. Air removal headers 33 connect to air removal manifold 39 which connects to an air extraction system 62 (FIG. 6).

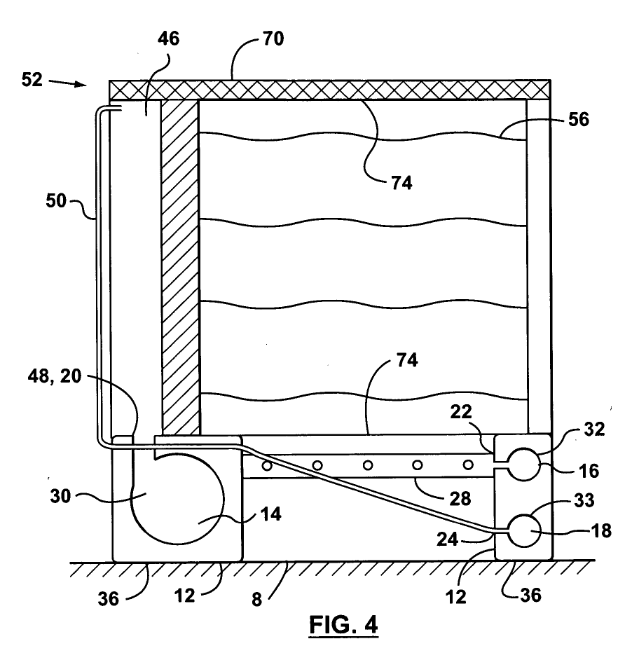

The basic horizontal module 52 resembles a standard ZW-1000 module with a different permeate header 46 (FIG. 4). The permeate header 46 has the permeate port 48 at the bottom of the header 46 (instead of the back for the current ZW-1000) to connect to the permeate conduit 14 in the pedestal 12. A fine tube 50 (3-5 mm) is inserted into the top portion of the header 46 and connected to the air removal conduit 18.

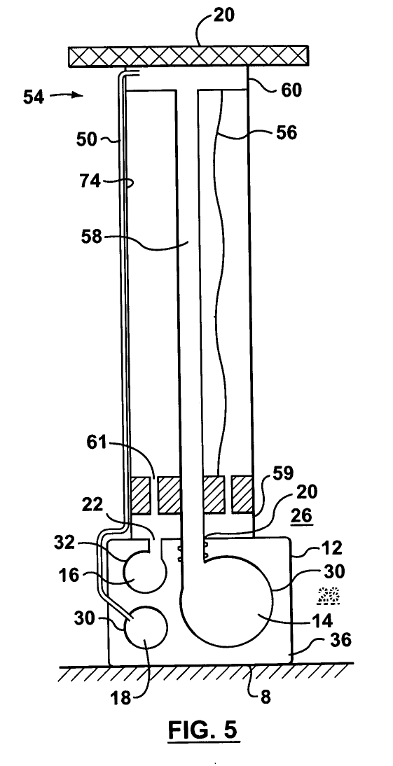

FIG. 5 shows a section view of a vertical module 54 with vertical fibres 56 on a pedestal 12. The module shown is cylindrical, with radially and circumferentially distributed air holes through the potting material of the lower header, although rectangular shaped headers may also be used. The vertical module 54 has a central permeate tube to bring the filtered water to the bottom permeate conduit 14 in the pedestal 12. The vertical module 54 also has an air distribution chamber 59 which releases air through air passages 61.

FIGS. 4 and 5 show a continuous flexible air removal tube 50 connecting the top of the module permeate cavity 60 to the air removal conduit. In practice, two sections of this tube 50 may be integrated into the header 46 and the pedestal 12, respectively, and connected together via a quick-connect mechanism (not shown) when the module 52, 54 is inserted into position.

For both module 52, 54 configurations, air is removed from the permeate header 46 (air from degassing or after a membrane integrity test) through the fine air removal tube 50, the air removal conduit 18 and an air extraction system 62 (FIG. 6). The air extraction system 62 is common to all membrane rows in the tank 10 although individual rows may be isolated by air removal isolation valves 77, for example when a row is taken out of service. The air extraction system may run throughout permeation, but only has to handle a very small fraction of the permeate flow because head loss through the fine tubes 50 causes very low flow rates even though the pressure in the air extraction system is lower (i.e., the air extraction system 62 has a stronger vacuum) than the permeate withdrawn system. The air extraction system 62 receives air or permeate or both through the air removal manifold 39. Vacuum pump 66 is operated to draw air from the air removal manifold 39. When all air has been drawn out, an amount of permeate may also be drawn into air extraction chamber 65. This permeate is removed by liquid pump 68, which may also be a drain. Liquid pump 68 turns on whenever a sensor indicates that extraction chamber 64 has a certain level of liquid in it. In this way, when air is present in the header 46, it is sucked through this network; when not, permeate is extracted. The vacuum applied through this system can by higher than that applied through the permeate extraction network since the amount of permeate flow will be limited by pressure loss through the fine tube 50 section which allows the air extraction system 62 to run during permeation to remove incidental air. On plant or row startup, or after an integrity test, the air extraction system 62 may be run for a period of time before starting permeation to remove air and fully or partially prime the permeate system.

The top of the module 52, 54 has a plastic cover 70 that forms a walk-on platform 72 when all modules 52, 54 are installed into the tank. Each module 52, 54 has built-in screens 74 at the bottom and at the top (horizontal fiber module 52) or around the periphery (vertical fibre module 54).

Immersed Membrane Sand Filter Retrofit Kit Operation

For a simpler retrofit of existing sand filters, the process should have filtration rates comparable to conventional sand filters. Table 1 shows that only 1 layer of ZW-1000 like modules at a flux of 30 L/m²/h will allow a filtration rate of 15 m/h, higher than most existing filters. For vertical modules, a filtration rate of 15 m/h could be obtained with a larger diameter and shorter fibre than what is currently used in ZW-1000.

TABLE 1
Comparison of filtration rates

Filtration Rate

| Filtration Process | m/h | gpm/ft² |
|---|---|---|
| Conventional sand filter | 5-10 | 2-4 |
| High rate sand filter | 20 | 8 |
| ZW-1000 - 3 module high (80% coverage) | 100 | 40 |
| @ 60 L/m²/h | | |
| ZW-1000 - 1 module high (80% coverage) | 15 | 6 |
| @ 30 L/m²/h | | |

The different functions of a membrane filter are reviewed below.

Filtration

Filtration is by gravity using the existing control mechanism at the plant. Assuming an available head of 2 m (0.2 bar or 20 kPa), a fouled membrane permeability of 150 L/m²/h/bar would allow the membranes to run at a flux of 30 L/m²/h. This is possible with modern microfiltration or ultrafiltration membranes, some of which have a clean water module permeability of about 400 L/m²/h/bar or more.

Backwash

Membrane backpulse is done using existing sand filter backwash pumps. Sand filters are typically backwashed 1/d, using 4-6% of the water filtered. Membrane filters can use roughly the same total amount of water, but with shorter more frequent backwashes.

Module Air Scouring

Use existing blower system or add blower for older sand filters that do not have air/water backwash. Isolation valves may be added between the air manifold 38 and the individual aeration headers 32 to allow non-operating rows to be isolated.

Air Removal

Air is removed from each module using the air extraction system 62.

Deconcentration

The primary deconcentration method is overflow using existing backwash troughs 76. Total or partial tank drains are also possible if a connection can be made from the bottom of the tank to the backwash water tank.

Chemical Cleaning

This is the unit operation that requires the most changes to existing sand filters (coating surfaces, adding CIP network and neutralization equipment). Lowering the membrane packing density (as compared to current ZW-1000 designs) to approach the filtration rate of existing filters negatively impacts the volume of cleaning solutions. This is offset by reduced fouling rates from operation at lower fluxes. The cleaning procedure includes daily (or less frequent) chlorine maintenance cleaning (acid/base can be used as an alternative) by soaking, using the scouring aeration network or the air removal network for distribution of the cleaning solution, and in-line neutralization on the drain line. Manual recovery cleaning may also be done once or twice per year.

Membrane Integrity Test

MITs are done continuously on a rotation basis on a module groups such as a full row using connections (not shown) to the permeate headers 30.

Module Isolation and Repair

A full row of modules are isolated from the permeate manifold 40 upon failure with a valve 78 at the end of a row that can be accessed from the top of the tank 10 (FIG. 3b). Other isolation valves similarly isolate a row from the other manifolds 38, 39.

I claim:

1. A membrane filtration apparatus comprising any of:
a) a module pedestal with interconnected permeate and air headers;
b) permeate connection at the bottom of each module;
c) cassette-less construction;
d) walking deck part of module;
e) air removal within each header using vacuum tube line; or f) air removal conduit independent of permeate header and situated below air inlet level.

2. A process comprising the steps of providing an apparatus according to claim 1 and operating the apparatus to filter water.
